(19) United States
(12) Patent Application Publication
(10) Pub. No.: US 2006/0236828 A1
(43) Pub. Date: Oct. 26, 2006

(54) Cutting or grinding machine

(76) Inventor: Kazumasa Ohnishi, Niigata (JP)

Correspondence Address: NIXON PEABODY, LLP, 401 9TH STREET, NW, SUITE 900, WASHINGTON, DC, 20004-2128, US

(21) Appl. No.: 11/319,206

(22) Filed: Dec. 28, 2005

(30) Foreign Application Priority Data
Apr. 25, 2005 (JP) 2005-154585
May 2, 2005 (JP) 2005-161957
Jun. 27, 2005 (JP) 2005-214964

(51) Int. Cl. B23B 29/00

(52) U.S. Cl. 82/158; 82/904

(57) ABSTRACT

A cutting or grinding machine is composed of a processing unit having a substrate and an exchangeable cutting or grinding rod fixed to the substrate at its middle portion or rear end, and a rotatable unit having a rotatable support for workpiece, in which the cutting or grinding rod has a ultrasonic transducer on the rod in an area between a front end of the rod and a portion at which the rod is fixed to the substrate.

### FIELD OF THE INVENTION

This invention relates to a cutting or grinding machine equipped with a ultrasonic transducer which is favorably employable for processing an article of rigid material such as inorganic glass, silicon, silicon nitride, or hard metal. The invention further relates to a cutting or grinding rod favorably employable for processing an article of rigid material.

### BACKGROUND OF THE INVENTION

A cutting or grinding machine in which a rotating workpiece is processed by means of a fixed cutting or grinding rod is well known.

FIG. 1 illustrates a known cutting machine using a throw-away tip as cutting m The cutting machine 10 comprises:

a processing unit comprising a substrate 11 and an exchangeable cutting rod 12 fixed to the substrate 11 at a middle portion or rear end thereof, and

a rotatable workpiece support nit comprising a rotatable support 13 for supporting a workpiece 14. The cutting rod 12 has a throw-away cutting tip 15 on the front end.

The cutting machine 10 of FIG. 1 is operated in the following machine.

The support 13 together with the workpiece 14 is rotated around its axis by means of a motor (not shown) connected to the support 13. The cutting rod 12 is advanced from the substrate 11 using a position-adjusting means so that the throw-away cutting tip 15 can be engaged with the workpiece 14 to cut the predetermined portion out.

Japanese Patent Provisional Publication No. 7-164217 describes a cutting machine 20 equipped with a ultrasonic transducer, as is illustrated in FIG. 2. In FIG. 2, the cutting machine 20 is composed of a cutting rod 21 equipped with a deflective rod 22 and a throw-away cutting tip 23. The cutting rod 21 is attached to a horn 24 which is fixed to a Langevin ultrasonic transducer 25. The Langevin ultrasonic transducer 25 is connected to an electric power supply 26. In the vicinity of the rear end of the Langevin ultrasonic transducer 25, a fan 27 is arranged. The combined structure of the cutting rod 21, horn 24 and Langevin ultrasonic transducer 25 is firmly supported in a cylindrical housing 28 by means of a flange 29.

The ultrasonic cutting machine 20 of FIG. 2 can be employed in combination with the rotatable workpiece support unit of FIG. 1. When the ultrasonic cutting machine 20 of FIG. 2 is employed for processing the workpiece 14 of FIG. 1, the Langevin ultrasonic transducer 25 generates ultrasonic vibration and the horn 24 enlarges and transmits the ultrasonic portion to the cutting rod 21. The vibration applied to the cutting rod 21 is then transmitted to the deflective rod 22 to cause defective motion therein. The deflective motion is applied to the throw-away cutting tip 23. In the case that the workpiece 14 is processed by the throw-away cutting tip 23 with the defective motion, the precision of the processing is enhanced.

The present inventor studied the ultrasonic cutting machine of FIG. 2 and has found that the ultrasonic cutting machine of FIG. 2 has problem in that not a small portion of the ultrasonic energy generated in the ultrasonic transducer is absorbed by the cylindrical housing through the flange in the course of its transmission toward the cutting rod. In order to compensate the loss of the ultrasonic energy, it is re ed to use a ultrasonic generator having a large capacity, such as that employed in FIG. 2.

### SUMMARY OF THE INVENTION

Accordingly, it is an object of the invention to provide a ultrasonic cutting or grinding machine that can utilize a generated ultrasonic energy efficiently.

It is another object of the invention to provide a ultrasonic cutting or grinding machine which an be constructed in a relative small size.

The present invention resides in a cutting or grinding machine comprising a processing unit comprising a substrate and an exchangeable cutting or grinding rod fixed to the substrate at a middle portion or rear end thereof, and a rotatable unit comprising a rotatable support for workpiece, wherein the cutting or grinding rod has a ultrasonic transducer thereon in an area between a front end of the rod and a portion at which the rod is fixed to the substrate.

### BRIEF DESCRIPTION OF THE DRAWING

FIG. 1 illustrates a conventional cutting machine.

FIG. 2 illustrates a known cutting machine equipped with a ultrasonic transducer.

FIG. 3 illustrates an example of the cutting or grinding machine according to the invention.

FIG. 4 illustrates an example of the cutting rod according to the invention.

FIG. 5 illustrates another example of the cutting rod according to the invention.

FIG. 6 is a schematic view of a further example of the cutting rod according to the invention.

FIG. 7 illustrates another example of the cutting or grinding machine according to the invention.

FIG. 8 illustrates a plan view of a still further example of the cutting rod according to the invention.

FIG. 9 illustrates a front view of the cutting rod of FIG. 8.

FIG. 10 illustrates a schematic view of a still further example of the cutting rod according to the invention.

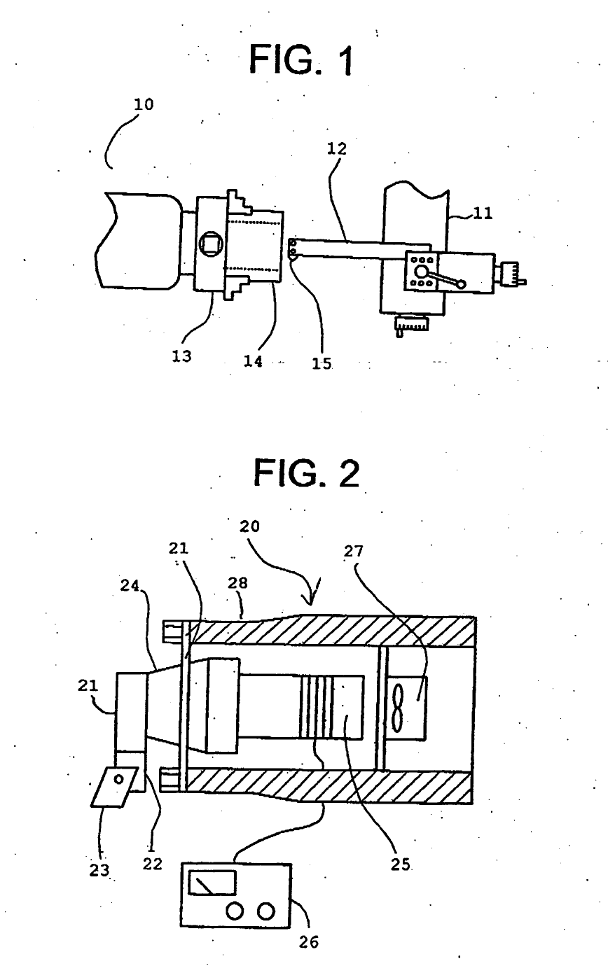

### DETAILED DESCRIPTION OF THE INVENTION

Preferred embodiments of the cutting or grinding rods employable for manufacturing the cutting or grinding machine of the invention are described below.

(1) The cutting or grinding rod has the ultrasonic transducer therearound in the form of a continuous or divided ring.

(2) The cutting or grinding rod is a rod having a grind stone at a front end thereof.

(3) The cutting or grinding rod is an end mill or a drill.

(4) The cutter or grinding rod comprises a holder rod and a throw-away tip attached to the holder rod.

(5) The cutting or grinding rod comprises a holder rod and a throw-away tip attached to the holder rod, and the ultrasonic transducer is placed on the throw-away tip.

The present invention is further described by referring to the figures shown in the attached drawings.

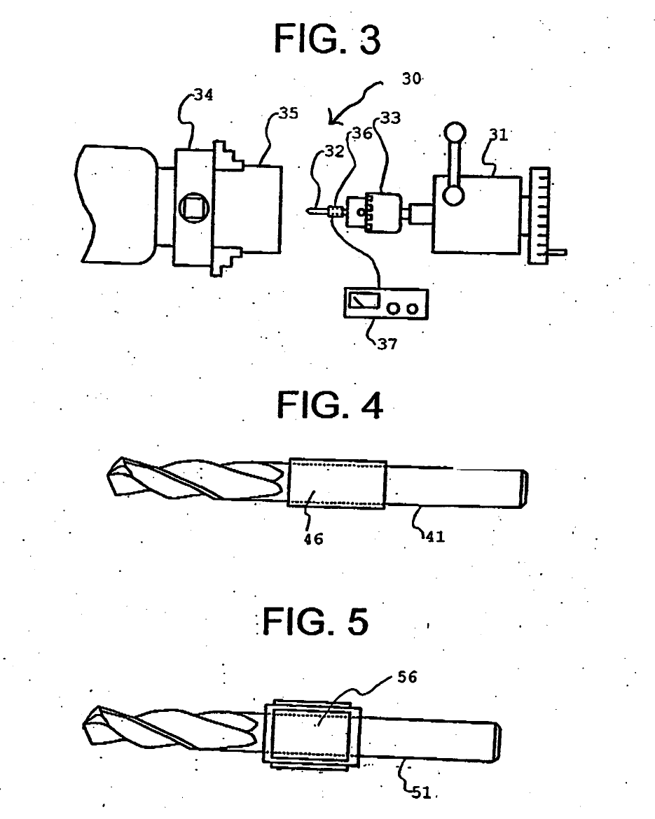

FIG. 3 illustrates an example of the cutting or grinding machine according to the invention.

In FIG. 2, a cutting or grinding machine 30 comprises a processing unit comprising a substrate and an exchangeable cutting or grinding rod fixed to the substrate 31 by means of a chuck 33 at a middle portion or rear-end of the rod 32, and a rotatable unit comprising a rotatable support 34 and a workpiece 35 fixed to the support 34. The cutting or grinding rod 32 has a ultrasonic transducer 36 on the rod in an area between a front end of the rod and a portion at which the rod is fixed to the substrate, that is, the position gripped with the chuck 33. The ultrasonic transducer 36 is connected to an electric power source 37.

The cutting or grinding procedure can be carried out in the following manner using the cutting or grinding machine of FIG. 3 according to the invention.

The substrate 34 together with the workpiece 15 is rotated around its axis by means of a motor (not shown) connected to the substrate. The cutting rod 32 and the chuck 33 are advanced in combination from the substrate 31 using a position-adjusting means so that the front end of the cutting rod 32 can be engaged with the workpiece 14 to cut the predetermined portion out. Before the advance movement of the cutting rod 32, the ultrasonic transducer 36 is activated, and then rates ultrasonic vibration and transmits the ultrasonic vibration to the cutting rod 32. The vibration applied to the cutting rod 32 is effective to more precisely process the workpiece 35. Thus, the ultrasonic vibration generated in the ultrasonic transducer 36 is transmitted directly and almost predominantly to the front end of the rod 32. Only a small amount of the generated ultrasonic vibration is transmitted to the position in contact with the chuck 33. Accordingly, the generated ultrasonic vibration is very efficiently utilized to vibrate the cutting or grinding rod.

Each of FIGS. 4 and 5 illustrates a cutting rod according to the invention.

The cutting rod of FIG. 4 is a drill 41, and the drill 41 has a ultrasonic transducer 46 therearound in the middle portion. Thus, the ultrasonic transducer can be in the form of continuous ring.

The cutting rod of FIG. 5 is a drill 51, and the drill 51 has a ultrasonic transducer 56 therearound in the middle portion. The ultrasonic transducer is composed of four ultrasonic transducers which are placed around the rod 51 via an intermediate plate. Thus, the ultrasonic transducer can be in the form of divided ring.

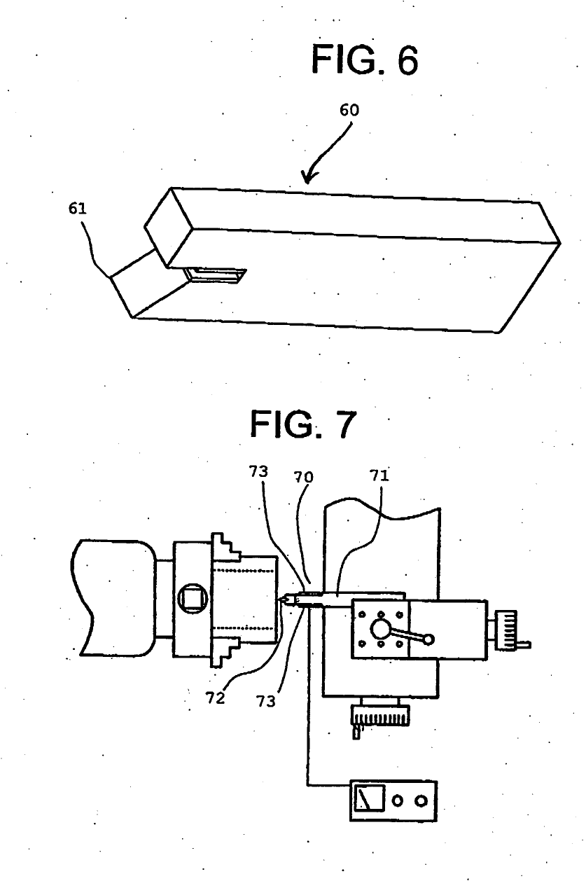

The cutting rod can be in the form of two forks as is shown in FIG. 6. One fork 61 of the cutting rod 60 has a cutting end. A pair of ultrasonic transducers 62 are placed between the two forks.

FIG. 7 has a cutting machine which is essentially the same as that of FIG. 3, except for the cutting rod 70 is composed of a holder 71 and a throw-away cutting tip 72. The holder 71 has therearound a ultrasonic transducer 73 in the form of ring.

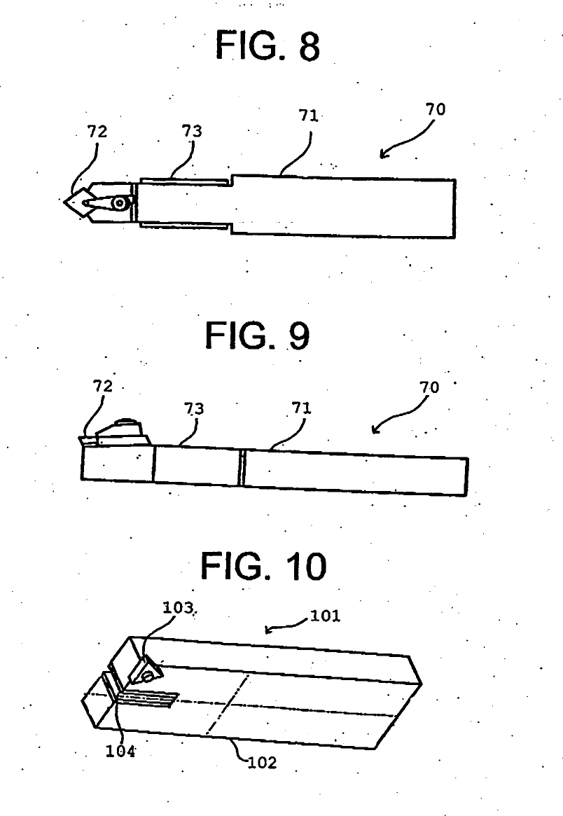

FIGS. 8 and 9 illustrate the cutting rod 70 employed in the cutting machine shown in FIG. 7.

As is shown in FIG. 10, the cutting rod 101 can comprise a two-forks holder 102, a throwaway cutting tip 103, and a pair of ultrasonic transducers 104 each of which is placed between the forks of the holder 102.

What is claimed is:

1. A cutting or grinding machine comprising a processing unit comprising a substrate and an exchangeable cutting or grinding rod fixed to the substrate at a middle portion or rear end thereof, and a rotatable unit comprising a rotatable sport for workpiece, wherein the cutting or grinding rod has a ultrasonic transducer thereon in an area between a front end of the rod and a portion at which the rod is fixed to the substrate.

2. 7he cutting or grinding machine of claim 1, wherein the cutting or grinding rod has the ultrasonic transducer therearound in the form of a continuous or divided rind.

3. The cutting or grinding machine of claim 1, wherein the cutting or grinding rod is a rod having a grind stone at a front end thereof.

4. The cutting or grinding machine of claim 1, wherein the cutting or grinding rod is an end mill or a drill.

5. The cutting or grinding machine of claim 1, wherein the cutting or grinding rod comprises a holder rod and a throw-away tip attached to the holder rod.

6. The cutting or grinding machine of claim 5, wherein the ultrasonic transducer is placed on the throw-away tip.
